(19) United States
(12) Patent Application Publication
(10) Pub. No.: US 2025/0125609 A1
(43) Pub. Date: Apr. 17, 2025

(54) Power Management Circuit with Inrush-Protection Device Bypass

(71) Applicant: SiliconBrite Technologies, Inc., Santa Clara, CA (US)

(72) Inventors: Cameron Nathan Jackson, Los Gatos, CA (US); Baris Karagozlu, Dublin, CA (US)

(73) Assignee: SiliconBrite Technologies, Inc., Santa Clara, CA (US)

(21) Appl. No.: 18/614,359

(22) Filed: Mar. 22, 2024

Related U.S. Application Data
(60) Provisional application No. 63/590,464, filed on Oct. 15, 2023.

(51) Int. Cl. H02H 7/125; H02M 7/217

(52) U.S. Cl. CPC H02H 7/125; H02M 7/217

(57) ABSTRACT

An inrush current protection system includes power terminals for connection to a power source and a load, with a sequence of devices connected in series between the power terminals. The sequence includes an inrush-protection device, a controlled switch, and a control circuit. The control circuit is configured to detect the voltage between the power terminals and wait for a predetermined time if the voltage is within an acceptable range. After the wait time, the control circuit closes the controlled switch to bypass the inrush-protection device. This system provides protection against inrush current when the load powers up for safe and reliable operation of both the load and the system itself.

### REFERENCES

This application claims priority from U.S. provisional patent application Ser. No. 63/590,464, entitled “Power Management Circuit with Inrush-Protection Device Bypass”, filed on Oct. 15, 2023. The priority application is hereby incorporated by reference, as if it is set forth in full in this specification.

Each publication, patent, and/or patent application mentioned in this specification is herein incorporated by reference in its entirety to the same extent as if each individual publication and/or patent application was specifically and individually indicated to be incorporated by reference.

### BACKGROUND

### Technical Field

The disclosed implementations relate generally to systems and methods used in power management circuits, and in particular to AC-to-DC and DC-to-DC converters that offer inrush current protection.

### Context

Power management systems and circuits, including integrated circuits (ICs), may be used to drive and protect an electric motor or other load that may not be purely resistive, and that draws a relatively high inrush current. They may further convert alternating current (AC) power to direct current (DC) power to drive the load. An inrush current is a higher current drawn for up to a few seconds after applying power, for example to accelerate a motor's rotor from its rest position to a steady speed, or to energize capacitive and inductive loads. Power management systems often provide overcurrent protection. Thresholds for overcurrent protection may be lower than the expected level of an inrush current. This might cause the overcurrent protection to be invoked when it should not be. A popular remedy is to couple a thermistor, e.g., a negative-temperature-coefficient (NTC) resistor, in series with the load. At startup, the thermistor is cold and has a high resistance. This prevents damage caused by the inrush current. As the thermistor warms up, its resistance decreases, and when the inrush current is over, there is some remaining efficiency impact. One of the disadvantages of this conventional protection is that after the device is switched off, it may take up to five minutes for the NTC to cool off and be ready to provide protection again. Another disadvantage is that even though the thermistor has much lower resistance when hot, it is still dissipating power, thereby reducing the energy efficiency for the system. Also, NTCs may not be short-circuit-proof, and they may burn out after a short circuit occurs. This leads to interruptions of service, and costs to repair or replace the power management circuit.

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves can also correspond to implementations of the claimed technology.

### BRIEF DESCRIPTION OF THE DRAWINGS

The technology will be described with reference to the drawings, in which:

FIG. 1 illustrates an example of a power management system including inrush current protection.

FIG. 2 illustrates an example method that starts a power management system on receiving a power-on-reset (POR) signal or a restart signal.

FIG. 3 illustrates an example of a power management system including inrush current protection and surge protection.

FIG. 4 illustrates another example of a power management system including inrush current protection and surge protection.

FIGS. 5A-B illustrate an example method that combines inrush current protection and surge protection.

FIG. 6 illustrates an example of a control circuit as may be used in the power management systems of FIG. 1 and FIGS. 3-4.

FIG. 7 illustrates an example variation on the control circuit of FIG. 6, with separate inputs for Vₛₙₛ₁ and Vₛₙₛ₂.

FIG. 8 illustrates an example of a combined swell and surge detector.

In the figures, like reference numbers may indicate functionally similar elements. The systems and methods illustrated in the figures—and described in the Detailed Description below—may be arranged and designed in a wide variety of different implementations. Neither the figures nor the Detailed Description are intended to limit the scope as claimed. Instead, they merely represent examples of different implementations.

### DETAILED DESCRIPTION

To overcome the conventional downsides of using a negative-temperature-coefficient (NTC) thermistor in a power management system with inrush current protection, implementations of the technology described herein use the inrush-protection device (a thermistor, a resistor, or an inductor) during startup when an inrush current may occur and bypass it after the inrush current has subsided. This document further discloses how the new inrush current protection interacts with other protections such as swell protection, surge protection, and V_{CC} monitoring.

### Terminology

As used herein, the phrase “one of” should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms “comprising” and “consisting” have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. “Coupled to” is generally used in the sense of directly coupled, whereas “coupled with” is generally used in the sense of directly or indirectly coupled. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item can be configured to perform the task even when the unit/circuit/component is not currently on or active. In general, the circuitry that forms the structure corresponding to configured to may include hardware circuits, and may further be controlled by switches, fuses, bond wires, metal masks, firmware, and/or software. Similarly, various items may be described as performing a task or tasks, for convenience in the description. Such descriptions should be interpreted as including the phrase configured to.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B”. This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase based on is thus synonymous with the phrase based at least in part on.

The terms “substantially”, “close”, “approximately”, “near”, and “about” refer to being within minus or plus 10% of an indicated value, unless explicitly specified otherwise.

The following terms or acronyms used herein are defined at least in part as follows:
“AC”—alternating-current
“CBEMA”—Computer Business Equipment Manufacturers Association
“CC”—control circuit
“DC”—direct current
“FET”—field-effect transistor
“IC”—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
“IGBT”—insulated-gate bipolar transistor
“ITIC”—Information Technology Industry Council
“LED”—light-emitting diode
“MOSFET”—metal-oxide-semiconductor field-effect transistor. Classes are NMOS (or N-type MOS), PMOS (or P-type MOS), and CMOS (complementary MOS, including both N-type and P-type devices).
“NTC”—negative-temperature-coefficient. The term NTC is often used for a temperature-dependent resistor (a thermistor) with a negative temperature coefficient.
“PCB”—printed circuit board
“POR”—power-on reset. A POR circuit is often used in integrated circuits to detect if sufficient operating voltage is available to support its functionality.
“PTC”—positive-temperature-coefficient. The term PTC is sometimes used for a temperature-dependent resistor (a thermistor) with a positive temperature coefficient.

A “surge” is generally a short-term event (less than half a second) where a voltage exceeds a maximum threshold. Surges can be positive or negative. For the purpose of this document, a surge is an event where the voltage exceeds a surge threshold. A short surge may have a duration of less than 100 microseconds, and a long surge may have a duration of less than 500 milliseconds. For fast detection of a surge, an implementation may monitor the rate of change of the voltage, as well as the voltage exceeding the maximum threshold. Some implementations may follow the Information Technology Industry Council (ITIC) or Computer Business Equipment Manufacturers Association (CBEMA) recommended overvoltage limits to distinguish between different types of surges and swells.

A “swell” is generally a longer-term event (greater than or equal to half a cycle of an AC power source) where a voltage exceeds a maximum threshold. Swells can be positive or negative. For the purpose of this patent document, a swell is an event where the voltage exceeds a predefined maximum threshold.

“TVS”—transient voltages suppressor.

### Implementations

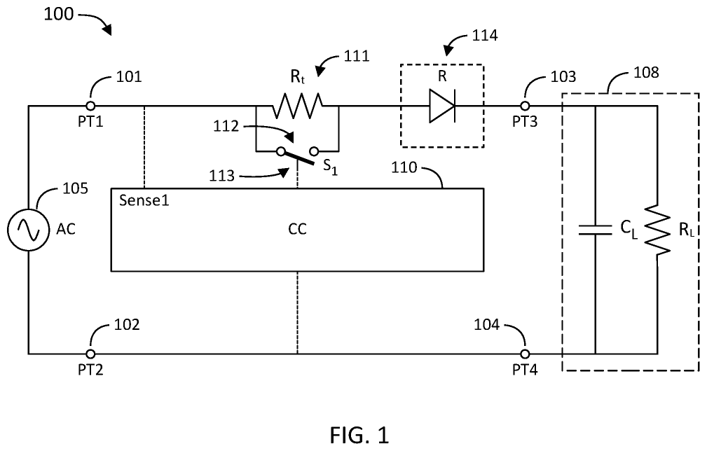

FIG. 1 illustrates an example of a power management system 100 including inrush current protection. FIG. 1 shows connections in the power's path as solid lines, whereas other connections, such as for control signals, are dotted lines. Power management system 100 includes a first power terminal PT1 101 and a second power terminal PT2 102. The first power terminal PT1 101 and the second power terminal PT2 102 may be coupled with a power source 105, for example an alternating-current (AC) power source such as mains power. It further includes a third power terminal PT3 103 and a fourth power terminal PT4 104, which are configured to be coupled with a load 108. The fourth power terminal PT4 104 is coupled with second power terminal PT2 102. If power source 105 has a neutral power rail, it might be coupled with second power terminal PT2 102, which may be directly connected to fourth power terminal PT4 104, and then to load 108.

Coupled between first power terminal PT1 101 and third power terminal PT3 103 is a sequence of devices coupled in series. Devices may be coupled in any order. The sequence of devices may include:
(a) An inrush-protection device 111 (Rₜ). In some implementations, inrush-protection device 111 is a temperature-dependent resistor (a thermistor). The thermistor may have a negative temperature coefficient (i.e., an NTC thermistor) or a positive temperature coefficient (i.e., a PTC thermistor). In other implementations it may be or include a regular resistor (with a temperature sensitivity of 500 ppm/° C. or less). In yet other implementations, the inrush-protection device Rₜ includes an inductor, or may be any combination of regular resistors, thermistors, and/or inductors.
(b) A rectifier 114 (R) in case power source 105 is an AC power source. Rectifier 114 may include a diode, a half-bridge rectifier, a full-bridge rectifier, a synchronous rectifier, or a partially synchronous rectifier.

Third power terminal PT3 103 and fourth power terminal PT4 104 may be coupled with load 108 whose behavior may include a resistive part (shown as R_{L}), a capacitive part (shown as C_{L}), and/or an inductive part (not shown). The load resistance R_{L} may represent electrical losses, mechanical losses, power exerted by the load on objects external to the load, or power emitted or transferred such as in the form of light or other radiation. The load capacitor C_{L} may represent electrical capacitance, as well as mechanical memory or other time-related phenomena. Load capacitor C_{L} may include a single capacitor or multiple capacitors, for example in a series-parallel arrangement. Load capacitor C_{L} may include a polarized capacitor, or a non-polarized capacitor, and such a capacitor may be electrolytic. In general, load 108 may have any complex behavior. Power management system 100 further includes a first controlled switch 112 (S₁) with two switch terminals and a first control terminal 113. First controlled switch 112 is coupled in parallel with inrush-protection device 111. Also included is a control circuit CC 110 that is coupled with first power terminal PT1 101, second power terminal PT2 102, and first control terminal 113. Control circuit CC 110 can close first controlled switch 112 S₁ by asserting first control terminal 113, and open S₁ by de-asserting first control terminal 113. First controlled switch 112 S₁ may be implemented as a relay or as a semiconductor device such as an IGBT, a thyristor, a MOSFET, a junction FET, a bipolar transistor, or any other controlled switch device with a resistance of less than 2 ohms between the two switch terminals when the controlled switch device has been switched on, i.e., its ON resistance is less than 2 ohms. In some implementations, first controlled switch 112 S₁ switches off very fast, for example a relay switches off within 20 milliseconds and a semiconductor switch switches off within 5 microseconds after first control terminal 113 has been de-asserted.

An implementation of control circuit CC 110 may include a printed circuit board (PCB) with discrete devices, one or more integrated circuits (ICs), modules, or any combination of those. Control circuit CC 110 detects the presence of a minimum voltage between first power terminal PT1 101 and second power terminal PT2 102. For example, a power-on-reset (POR) circuit in control circuit CC 110 may detect if the voltage between first power terminal PT1 101 and second power terminal PT2 102 is within an acceptable range (for load 108 and/or for control circuit CC 110 itself). When control circuit CC 110 detects that the voltage between first power terminal PT1 101 and second power terminal PT2 102 is within an acceptable range, control circuit CC 110 waits for a first wait time before asserting first control terminal 113 to close first controlled switch 112 S₁ to bypass inrush-protection device 111 Rₜ. The first wait time may be as short as a quarter cycle of the AC power source, or as long as several seconds. For example, for a load that stores energy in a parasitic capacitance, a bus capacitor, or an inductance, the first wait time may be just four milliseconds (4 ms), whereas for a load that stores energy in a mechanical system, such as an electric motor, the first wait time may be as long as five seconds (5 s). In some applications, the first wait time may be as long as thirty seconds (30 s).

Before system startup, i.e., before load 108 is first coupled with power source 105, no current flows through inrush-protection device 111 Rₜ. If Rₜ is an NTC thermistor, it is relatively cold, and its resistance is relatively high. When load 108 is first coupled with power source 105, inrush-protection device 111 Rₜ limits the current through rectifier 114 and load 108. Inrush currents are limited, and voltage spikes cannot damage power management system 100 within the normal voltage operating range of S₁. The inrush current through inrush-protection device 111 Rₜ heats it and lowers its resistance (if it is an NTC). Once the inrush current is over and a steady current level has been reached, the resistance of Rₜ may be low, but it is not zero, and therefore Rₜ may dissipate power, lowering the system's efficiency. The first wait time is designed, selected, or configured to be a bit longer than the expected duration of the inrush current. When control circuit CC 110 has waited for the first wait time, it closes first controlled switch 112 S₁, which bypasses inrush-protection device 111 Rₜ. Most current no longer flows through inrush-protection device 111 Rₜ, which may cool off and raise its resistance (if it is an NTC). Instead, most current flows through first controlled switch 112 S₁, which because of its low on-resistance dissipates little power, allowing a higher system efficiency.

It is possible that a swell or surge in the voltage from power source 105, or a short circuit or other fault condition in load 108 creates a dangerous, harmful, or otherwise undesirable situation. To address this, in some implementations control circuit CC 110 monitors the voltage between first power terminal PT1 101 and second power terminal PT2 102, for example via a sense input (Sense1). A sense voltage Vₛₙₛ₁ may be directly measured on the sense input, or internally derived from the voltage on the sense input, for example via a peak detector, a voltage divider, and/or a filter. For a short-term event, when the voltage exceeds a maximum voltage threshold, and in some implementations a maximum voltage rate-of-change threshold, control circuit CC 110 may de-assert first control terminal 113. First controlled switch 112 S₁ opens, and inrush-protection device 111 Rₜ is no longer bypassed. The current is now forced to pass through inrush-protection device 111 Rₜ, which limits the surge voltage that is coupled forward to load 108.

Some implementations may include a surge suppression component (not shown) coupled between third power terminal PT3 103 and fourth power terminal PT4 104, such as a metal-oxide varistor, a transient voltages suppressor (TVS), a spark gap, or any combination thereof. Control circuit CC 110 may have other interfaces (not shown) with external devices, such as a serial interface for communication with an external processor or device, indicator outputs such as for light-emitting diodes (LEDs), pins for external capacitors that set timing constants, etc.

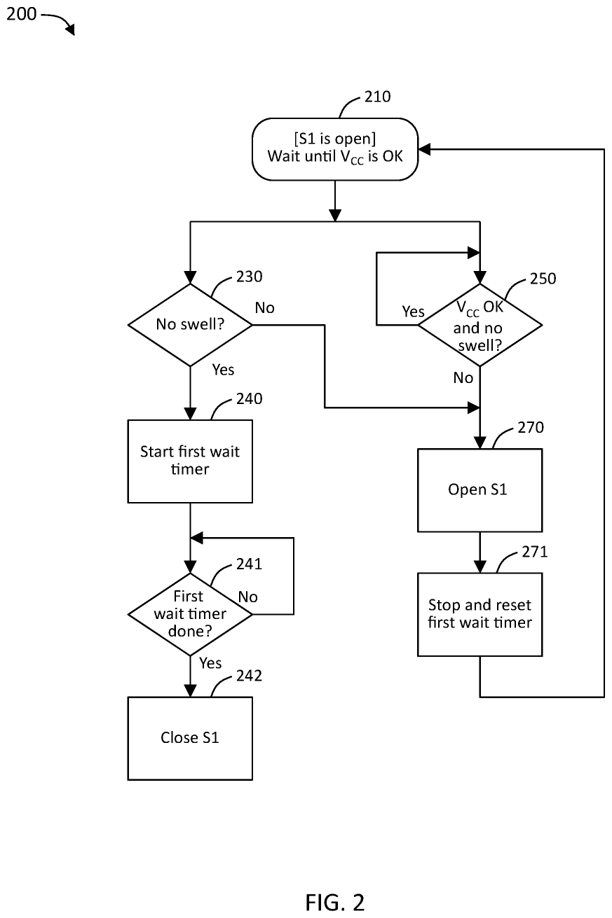

FIG. 2 illustrates an example method 200 of using a power management system. It may start on receiving a power-on-reset (POR) signal or another signal that the power management system (and possibly the load) has a sufficiently high voltage to operate. This signal may be derived from monitoring a supply voltage V_{CC}, for example of an IC or other circuits in the power management system. Method 200 assumes that at its start, the first controlled switch S₁ is open. Method 200 has the following steps.

Step 210—waiting until a sufficient supply voltage is present (e.g., V_{CC} is OK). Two independent processes may start at this point, described with reference to Step 230 (for inrush protection) and Step 250 (internal supply voltage monitoring and sense voltage monitoring).

Step 230—determining if the first sense voltage is in the correct range, i.e., if no swell is present. Some implementations compare Vₛₙₛ₁ with a single threshold, for example an upper threshold, and other implementations compare Vₛₙₛ₁ with two thresholds, for example both an upper and a lower threshold. In the example of FIG. 1, the voltage at the first sense input Sense1 may be a 230V AC signal. The first sense voltage Vₛₙₛ₁ may be derived from the voltage at the first sense input using a peak detector that detects a nominal 235V peak value, and a voltage divider/low-pass filter that divides the peak voltage by 100 to give a nominal divided peak value of 2.35V. The implementation may compare the nominal divided peak value with a threshold voltage of 2.585V to determine if the AC voltage of power source 105 is less than 10% above its nominal value. The low-pass filter limits measured effects to slow events, such as swells. Other implementations may use a high-pass filter to measure fast events such as surges, or may not have a peak detector because power source 105 may deliver a DC voltage, or may not have a need for a voltage divider. An implementation may detect a swell by comparing the measured voltage with a maximum voltage threshold, and optionally a surge by comparing the rate of change of the measured voltage with a voltage rate-of-change threshold. Some implementations compare the measured voltage with a maximum voltage threshold that is modified by the rate of change of the measured voltage.

When the implementation determines that the first sense voltage Vₛₙₛ₁ is not in the correct range (that a swell is present), the method proceeds to Step 270.

Step 240—upon determining that the first sense voltage is in the correct range, the implementation starts the first wait timer and continues with Step 241.

Step 241—waiting until the first wait timer has timed out. Note that a parallel thread in the method can reset the first wait timer (e.g., Step 271) and therefore the method may not always proceed with Step 242.

Step 242—closing the first controlled switch S₁ (if it is open). This step bypasses the inrush-protection device. Bypassing the inrush-protection device lowers its dissipation and provides a chance for its resistance to increase (if it is an NTC). This step occurs after the implementation has waited the first wait time in Step 241. The method may revert to Step 250.

Step 250—monitoring if the internal supply voltage V_{CC} and/or the first sense voltage Vₛₙₛ₁ are in the correct range. The internal supply voltage may be a supply voltage used by a part or all of the control circuit CC. If V_{CC} and/or Vₛₙₛ₁ are in the correct range, the process keeps monitoring. Details of monitoring the first sense voltage are described with respect to Step 230. If V_{CC} and/or Vₛₙₛ₁ are not in the right range, the method proceeds to Step 270. The process in Step 250 to Step 271 is optional.

Step 270—opening the first controlled switch S₁ (if is not open) to stop bypassing the inrush-protection device.

Step 271—stopping and resetting the first wait timer. The first wait timer may have been activated in an earlier occurrence of Step 240. After Step 271, the method returns to Step 210.

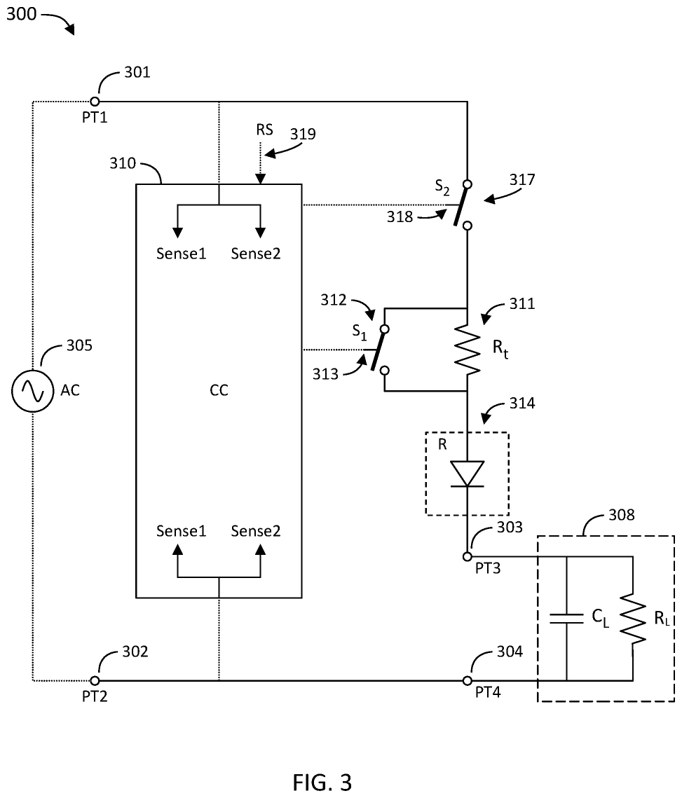

FIG. 3 illustrates an example of a power management system 300 including inrush current protection and swell and/or surge protection. Compared with FIG. 1, FIG. 3 adds a second controlled switch, and it has two sense inputs (internal or external). FIG. 3 shows connections in the power's path as solid lines, whereas other connections, such as for control signals, are dotted lines. Power management system 300 includes a first power terminal PT1 301 and a second power terminal PT2 302. The first power terminal PT1 301 and the second power terminal PT2 302 may be coupled with a power source 305, for example an alternating-current (AC) power source such as mains power. It further includes a third power terminal PT3 303 and a fourth power terminal PT4 304, which are configured to be coupled with a load 308. The fourth power terminal PT4 304 is coupled with second power terminal PT2 302. If power source 305 has a neutral power rail, it might be coupled with second power terminal PT2 302, which may be directly connected to fourth power terminal PT4 304, and then to load 308.

Coupled between first power terminal PT1 301 and third power terminal PT3 303 is a sequence of devices coupled in series. Devices may be coupled in any order. The sequence of devices may include:
(a) An inrush-protection device 311 (Rₜ). In some implementations, inrush-protection device 311 is a temperature-dependent resistor (a thermistor). The thermistor may have a negative temperature coefficient (i.e., an NTC thermistor) or a positive temperature coefficient (i.e., a PTC thermistor), and in other implementations it may be or include a regular resistor (with a temperature sensitivity of 500 ppm/° C. or less). In yet other implementations, the inrush-protection device Rₜ includes an inductor, or may be any combination of regular resistors, thermistors, and/or inductors. Coupled in parallel with inrush-protection device 311 is first controlled switch 312 (S₁) with two switch terminals and a first control terminal 313.
(b) A rectifier 314 (R) in case power source 305 is an AC power source. Rectifier 314 may include a diode, a half-bridge rectifier, a full-bridge rectifier, a synchronous rectifier, or a partially synchronous rectifier. In case rectifier 314 includes a full-bridge rectifier, part of the full-bridge rectifier may be coupled between second power terminal PT2 302 and fourth power terminal PT4 304.
(c) A second controlled switch 317 (S₂) with two switch terminals and a second control terminal 318.

Third power terminal PT3 303 and fourth power terminal PT4 304 may be coupled with load 308 whose behavior may include a resistive part (shown as R_{L}), a capacitive part (shown as C_{L}), and/or an inductive part (not shown). The load resistance R_{L} may represent electrical losses, mechanical losses, power exerted by the load on objects external to the load, or power emitted or transferred such as in the form of light or other radiation. The load capacitor C_{L} may represent electrical capacitance, as well as mechanical memory or other time-related phenomena. Load capacitor C_{L} may include a single capacitor or multiple capacitors, for example in a series-parallel arrangement. Load capacitor C_{L} may include a polarized capacitor, or a non-polarized capacitor, and such a capacitor may be electrolytic. In general, load 308 may have any complex behavior.

Power management system 300 further includes a control circuit CC 310 that is coupled with first power terminal PT1 301, second power terminal PT2 302, first control terminal 313, and second control terminal 318. Control circuit CC 310 can close first controlled switch 312 S₁ by asserting first control terminal 313, and open S₁ by de-asserting first control terminal 313. It can close second controlled switch 317 S₂ by asserting second control terminal 318 and open S₂ by de-asserting second control terminal 318. First controlled switch 312 S₁ and second controlled switch 317 S₂ may be implemented as a relay or as a semiconductor device such as an IGBT, a thyristor, a MOSFET, a junction FET, a bipolar transistor, or any other low-resistance controlled switch device. In some implementations, first controlled switch 112 S₁ switches off very fast, for example within 5 microseconds or even within 2 microseconds after first control terminal 113 has been de-asserted.

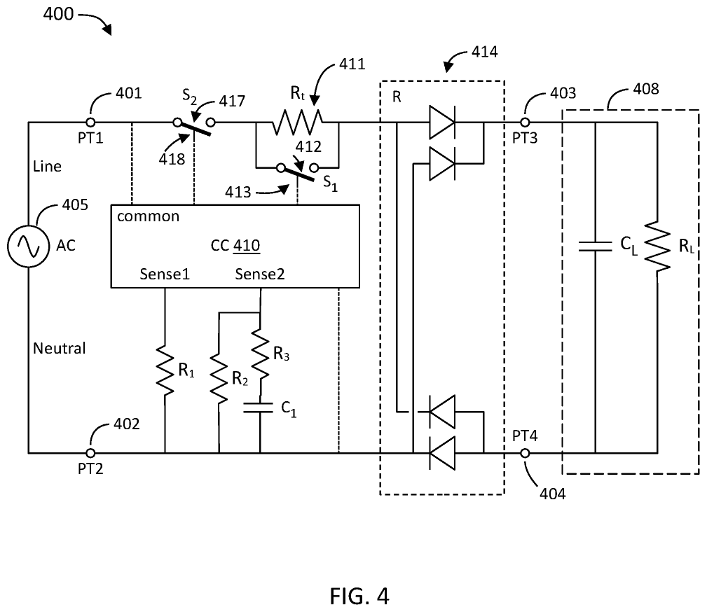

Control circuit CC 310 is configured to sense the voltage between first power terminal PT1 301 and second power terminal PT2 302 to determine if the voltage from power source 305 is in the right range, and to determine if a swell (slow) and/or surge (fast) occurs. In some implementations, as in the example of FIG. 3, control circuit CC 310 includes circuitry to distinguish between a swell and a surge (the Sense1 and Sense2 signals are internally separated). In other implementations, as in the example of FIG. 4, the control circuit has separate Sense1 and Sense2 inputs, and external circuits may be used to distinguish between a swell and a surge. Circuits to separate a first sense voltage Vₛₙₛ₁ and a second sense voltage Vₛₙₛ₂ may include a peak detector, voltage dividers, resistors, filters, and any other circuits that can meaningfully distinguish swell and surge events.

An implementation of control circuit CC 310 may include a printed circuit board (PCB) with discrete devices, one or more integrated circuits (ICs), modules, or any combination of those. Control circuit CC 310 detects the presence of a minimum voltage between first power terminal PT1 301 and second power terminal PT2 302. For example, a power-on-reset (POR) circuit in control circuit CC 310 may detect if the voltage between first power terminal PT1 301 and second power terminal PT2 302 is within an acceptable operating range (for load 308 and/or for power management system 300 itself). When control circuit CC 310 detects that the voltage between first power terminal PT1 301 and second power terminal PT2 302 is within an acceptable operating range, control circuit CC 310 closes second controlled switch 317 S₂ to apply power from power source 305 to load 308 via inrush-protection device 311, then waits for a first wait time before asserting first control terminal 313 to close first controlled switch 312 S₁ to bypass inrush-protection device 311 Rₜ. The first wait time may be as short as a quarter cycle of the AC power source, or as long as several seconds. For example, for a load that stores energy in a parasitic capacitance, a bus capacitor, or an inductance, the first wait time may be just four milliseconds (4 ms), whereas for a load that stores energy in a mechanical system, such as an electric motor, the first wait time may be as long as five seconds (5 s). In some applications, the first wait time may be as long as thirty seconds (30 s).

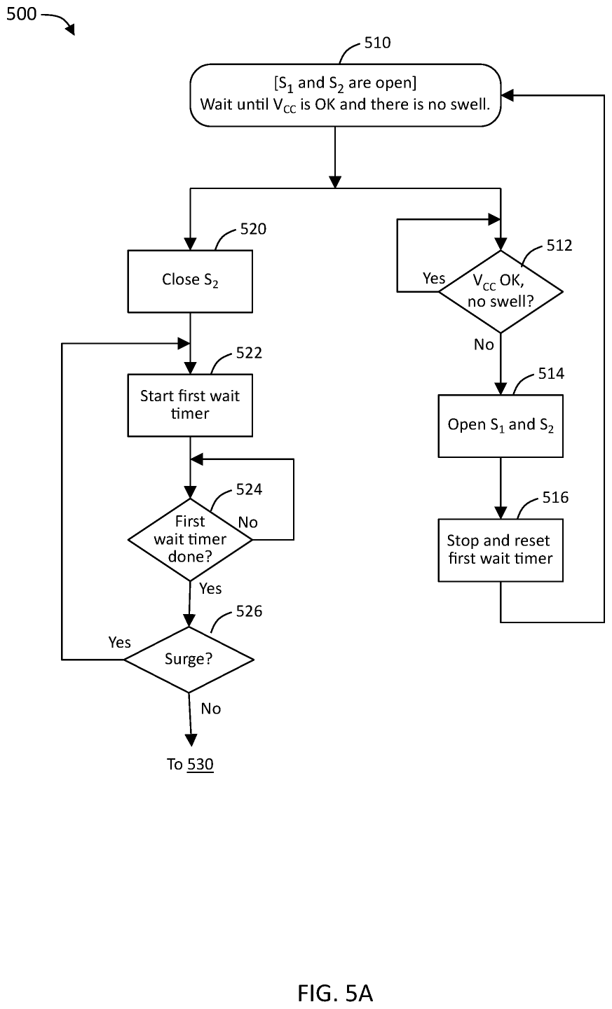

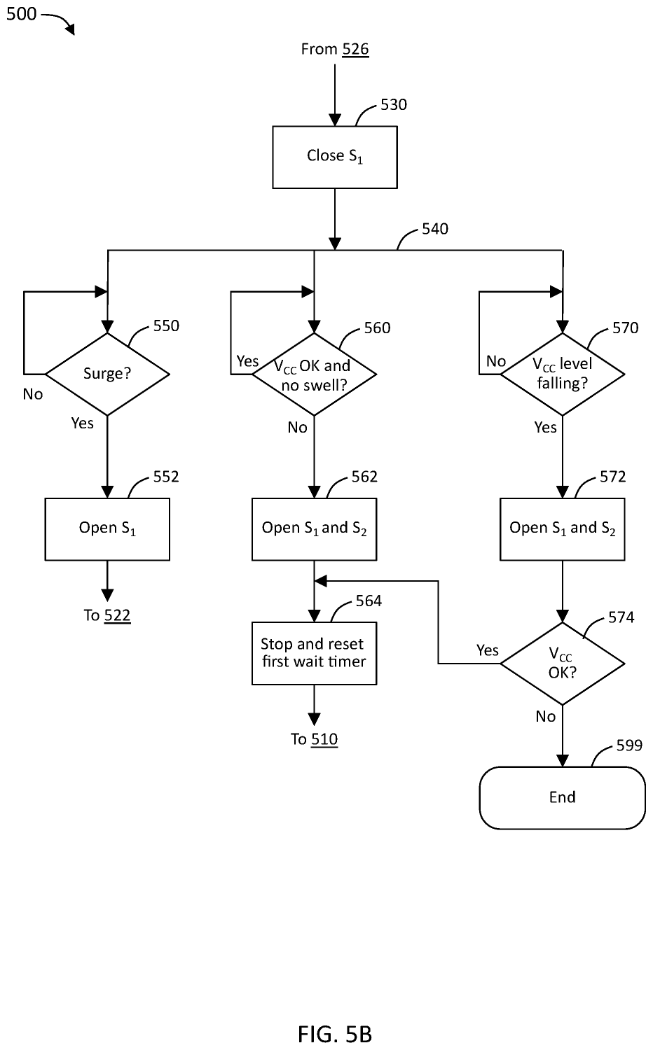

When a swell or surge occurs that takes the Vₛₙₛ₁ and Vₛₙₛ₂ voltages or Sense1 and Sense2 conditions out of the determined safe range, control circuit CC 310 may take various actions with respect to inrush-protection device 311 and second controlled switch 317 to protect both load 308 and power management system 300 itself. Examples of such actions are provided with reference to FIGS. 5A-B.

Control circuit CC 310 may have a reset input to receive a reset signal RS 319. Reset signal RS 319 may be provided from a physical switch, a software switch, a PCB link, an optocoupler, or any combination thereof. It may also be a signal that is internally generated by control circuit CC 310. A physical switch to provide reset signal RS 319 may be directly or indirectly coupled with first power terminal PT1 301 or second power terminal PT2 302.

FIG. 4 illustrates another example of a power management system 400 including inrush current protection and surge protection. Compared with FIG. 3, FIG. 4 uses two external sense inputs Sense1 and Sense 2, and it shows the use of a bridge rectifier. FIG. 4 shows connections in the power's path as solid lines, whereas other connections, such as for control signals, are dotted lines. Power management system 400 includes the first power terminal PT1 401 and the second power terminal PT2 402. The first power terminal PT1 401 and the second power terminal PT2 402 may be coupled with the power source 405, for example an alternating-current (AC) power source such as mains power. It further includes the third power terminal PT3 403 and the fourth power terminal PT4 404, which are configured to be coupled with the load 408. The fourth power terminal PT4 404 is coupled with the second power terminal PT2 402. If power source 405 has a neutral power rail, it might be coupled with second power terminal PT2 402, which may be couple with fourth power terminal PT4 404 via a part of bridge rectifier 414, and then to load 408.

Coupled between first power terminal PT1 401 and third power terminal PT3 403 is a sequence of devices coupled in series. Devices may be coupled in any order. The sequence of devices may include:
(a) The inrush-protection device 411 (Rₜ). In some implementations, inrush-protection device 411 is a temperature-dependent resistor (a thermistor). The thermistor may have a negative temperature coefficient (i.e., an NTC thermistor) or a positive temperature coefficient (i.e., a PTC thermistor), and in other implementations it may be or include a regular resistor (with a temperature sensitivity of 500 ppm/° C. or less). In yet other implementations, the inrush-protection device Rₜ includes an inductor, or may be any combination of regular resistors, thermistors, and/or inductors. Coupled in parallel with inrush-protection device 411 is first controlled switch 412 (S₁) with two switch terminals and the first control terminal 413.
(b) Part of the bridge rectifier 414 (R). Bridge rectifier 414 may include a diode, a half-bridge rectifier, a full-bridge rectifier, a synchronous rectifier, or a partially synchronous rectifier. In case bridge rectifier 414 includes a full-bridge rectifier, part of the full-bridge rectifier may be coupled between second power terminal PT2 402 and fourth power terminal PT4 404.
(c) The second controlled switch 417 (S₂) with two switch terminals and the second control terminal 418.

Third power terminal PT3 403 and fourth power terminal PT4 404 may be coupled with load 408 whose behavior may include a resistive part (shown as R_{L}), a capacitive part (shown as C_{L}), and/or an inductive part (not shown). The load resistance R_{L} may represent electrical losses, mechanical losses, power exerted by the load on objects external to the load, or power emitted or transferred such as in the form of light or other radiation. The load capacitor C_{L} may represent electrical capacitance, as well as mechanical memory or other time-related phenomena. Load capacitor C_{L} may include a single capacitor or multiple capacitors, for example in a series-parallel arrangement. Load capacitor C may include a polarized capacitor, or a non-polarized capacitor, and such a capacitor may be electrolytic. In general, load 408 may have any complex behavior.

Power management system 400 further includes the control circuit CC 410 that is coupled with first power terminal PT1 401, second power terminal PT2 402, first control terminal 413, and second control terminal 418. Control circuit CC 410 can close first controlled switch 412 S₁ by asserting first control terminal 413, and open S₁ by de-asserting first control terminal 413. It can close second controlled switch 417 S₂ by asserting second control terminal 418 and open S₂ by de-asserting second control terminal 418. First controlled switch 412 S₁ and second controlled switch 417 S₂ may be implemented as a relay or as a semiconductor device such as an IGBT, a thyristor, a MOSFET, a junction FET, a bipolar transistor, or any other low-resistance controlled switch device. In some implementations, first controlled switch 412 S₁ switches off very fast, for example within 5 microseconds or even within 2 microseconds after first control terminal 413 has been de-asserted.

In power management system 400, power source 405 has a Line rail that is coupled with first power terminal PT1 401 and a Neutral rail that is coupled with second power terminal PT2 402. For safety reasons, there are no other devices between second power terminal PT2 402 and fourth power terminal PT4 404 than part of bridge rectifier 414. Thus, control circuit CC 410 has a common terminal that is coupled with first power terminal PT1 401, and it derives its internal operating voltage V_{CC} from the Neutral line. Thus, to determine if voltages delivered by power source 405 are safe, it needs to sense the voltage at second power terminal PT2 402 with respect to the voltage at first power terminal PT1 401. The Sense1 input is configured to detect the occurrence of a swell, i.e., a relatively slow effect that takes the voltage from power source 405 out of the safe range. The Sense2 input is configured to detect the occurrence of a surge, i.e., a relative fast effect that takes the voltage from power source 405 out of the safe range. To detect a swell, external resistor R1 may convert the voltage at second power terminal PT2 402 to a current and/or internal voltage Vₛₙₛ₁, and to detect a surge, external filter R2, R3, and C1 provides high-pass functionality to generate internal voltage Vₛₙₛ₂. In general, circuits to convert the voltage on second power terminal PT2 402 to the internal voltages Vₛₙₛ₁ and Vₛₙₛ₂ may include a peak detector, voltage dividers, resistors, filters, and any other circuits that can meaningfully distinguish swell and surge events.

FIGS. 5A-B illustrate an example method 500 that combines inrush current protection and surge protection. Method 500 can be used on power management systems such as in FIGS. 3-4. The power management system includes a first controlled switch (S₁), a second controlled switch (S₂), a first wait timer (that may be inside the control circuit), and operates using a supply voltage V_{CC}. It is configured to detect the presence of a swell (for example, using Sense1 and Vₛₙₛ₁) and (optionally) of a surge (for example, using Sense2 and Vₛₙₛ₂). Method 500 comprises the following steps, some of which are optional:

Step 510—while the first controlled switch (S₁) and the second controlled switch (S₂) are open, waiting until V_{CC} is within an acceptable range and no swell is detected. Once V_{CC} is within an acceptable range and no swell is detected, the method continues with two parallel processes, one beginning with Step 512, the other with Step 520.

Step 512—continuously determining if V_{CC} is within the acceptable range and no swell is present.

Step 514—upon determining that V_{CC} is not within the acceptable range and/or that a swell is present, opening the first controlled switch and the second controlled switch.

Step 516—stopping and resetting the first wait timer and returning to Step 510.

Step 520—closing the second controlled switch (S₂). If a load is coupled with the power management system, this may couple the load with a power source.

Step 522—starting the first wait timer. The first wait timer may be an analog timer or a digital timer, or any electronic circuit that creates a delay and that can be stopped and/or reset.

Step 524—waiting until the first wait timer has timed out.

Step 526—(optional) determining if a surge is present. Upon determining that a surge is present, returning to Step 522.

Step 530—closing the first controlled switch (S₁).

Step 540—Upon closing the first controlled switch, method 500 may continue with several parallel processes, one (optional) beginning with Step 550, another with Step 560, and optionally a third beginning with Step 570.

Step 550—(optional) continuously determining if a surge is present.

Step 552—(optional) upon determining that a surge is present, opening the first controlled switch (S₁) and the second controlled switch (S₂) and returning to Step 522.

Step 560—continuously determining if V_{CC} is within the acceptable range and no swell is present.

Step 562—upon determining that V_{CC} is not within the acceptable range and/or that a swell is present, opening the first controlled switch and the second controlled switch.

Step 564—stopping and resetting the first wait timer and returning to Step 510.

Step 570—(optional) continuously determining if a level of V_{CC} is falling. An implementation may use the level of V_{CC} and compare it with a threshold. Another implementation may use a change in the level of V_{CC} and compare it with a threshold. Yet another implementation may use the level of V_{CC} and the change in the level of V_{CC} and compare it with one or more thresholds.

Step 572—(optional) upon determining that the level of V_{CC}, opening the first controlled switch (S₁) and the second controlled switch (S₂).

Step 574—determining if V_{CC} is within the acceptable range. Upon determining that V_{CC} is within the acceptable range, proceeding with Step 564.

Step 599—Upon determining that V_{CC} is not within the acceptable range, ending method 500. An implementation may end method 500 by, for example, shutting down the power management system, or by requesting user intervention.

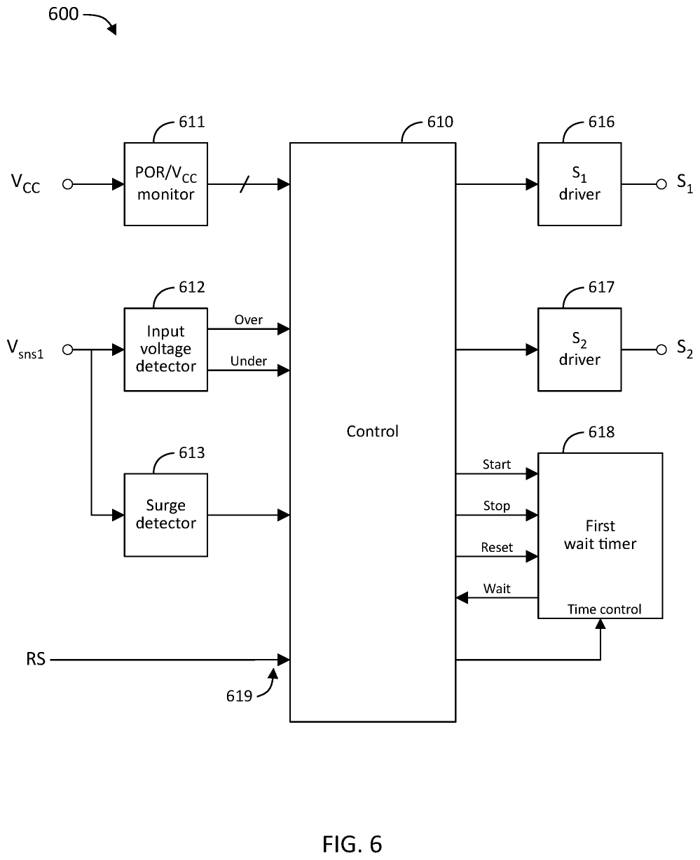

FIG. 6 illustrates an example of a control circuit 600 as may be used in the power management systems of FIG. 1 and FIGS. 3-4. The circuits described in FIG. 6 may be combined in an analog and digital mixed-signal integrated circuit and complemented with internal and/or external devices as described elsewhere in this document. Control circuit 600 includes control logic 610, which may comprise combinational logic and latches or registers, or a programmable controller, or any combination thereof, to perform functionality as described with reference to FIGS. 2 and 5A-B. Control logic 610 interfaces with several detectors, output drivers for the control terminals of the controlled switches S₁ and S₂, and one or more timers.

Power-on reset circuit (POR 611), which can also act as a full V_{CC} monitor, monitors if there is sufficient supply voltage V_{CC} available to support the functionality of control circuit 600. It may also monitor if the available supply voltage V_{CC} doesn't exceed an upper threshold, to support the functionality described in Step 230 and Step 250 of FIG. 2, or Step 510, Step 512, Step 560, Step 570, and Step 574 of FIGS. 5A-B. POR 611 may include a reference source and one or more comparators, and may provide control logic 610 with one or more signals such as “V_{CC} meets minimum requirements” (also known as the POR signal), “V_{CC} exceeds maximum allowed level”, or “V_{CC} level falling”.

An input voltage detector 612 monitors the input voltage Vₛₙₛ₁ (which may be or represent the voltage between the first power terminal PT1 and the second power terminal PT2). If Vₛₙₛ₁ is too low, input voltage detector 612 may issue an undervoltage signal, and if it is too high, input voltage detector 612 may issue an overvoltage signal to control logic 610. This functionality may be achieved with two comparators and a reference voltage. Input voltage detector 612 measures relatively slow changes in conditions, such as for example swells. It may perform a low-pass filter operation on Vₛₙₛ₁ to avoid being triggered by noise or surges.

A surge detector 613 also monitors the input voltage Vₛₙₛ₁. However, surge detector 613 is focused on fast changes in conditions. Therefore, it may monitor whether Vₛₙₛ₁ exceeds a voltage threshold, as well as a rate-of-change-in-voltage threshold. The thresholds may not be fixed. For example, the measured rate-of-change may impact the voltage threshold. Surge detector 613 may perform a high-pass filter function on Vᵢₙ to enable quickly being triggered by surges.

Several of the detectors may need to use a reference, such as a voltage reference. While each POR 611, input voltage detector 612, and/or surge detector 613 may have its own reference built-in, control circuit 600 may also include a separate reference source whose output is distributed to one or more of the detectors/monitors, which may then derive their individual reference levels, for instance by using voltage dividers, scaled current mirrors, or any other techniques.

A switch S₁ driver 616 and a switch S₂ driver 617 convert digital output signals of control logic 610 to signals capable of driving external controlled switches, such as IGBTs, thyristors, MOSFETs, junction FETs, bipolar transistors, relays, and/or any other low-resistance controlled switch devices.

A timer 618 is configured to output a wait signal upon receiving a start signal. The wait signal may be used as the first wait time, the second wait time, the third wait time, and/or the fourth wait time, as described elsewhere in this document. Some implementations may include a single timer. The single timer may have a time control to select between different durations for the wait signal, or to directly set the duration of the wait signal. The duration of the wait signal may be fixed, configurable, fixed and selectable, or configurable and selectable. Other implementations may include multiple timers, for example separate timers for each different relevant wait time. Timers may be implemented as digital circuits or as analog circuits, both of which are well known in the art.

A reset input may be configured to receive a reset signal RS 619 to cause a reset or restart of the power management system. The reset or restart signal may be needed when the second controlled switch has been deactivated. This may be due to a dangerous fault situation, and the dangerous situation may need to be corrected before it is safe again to apply power to the load. In some cases, a human user can inspect the situation, correct it if needed, and assert reset signal RS 619 to restart the power management system and reapply power to the load. In other cases, an automated system can correct the situation and assert reset signal RS 619. In yet other cases, the power management system may just wait a predetermined time and try automatically restarting the system.

Since control logic 610 interfaces with digital or digitized input signals and output signals, its functionality, described with reference to FIGS. 2 and 5A-B and elsewhere in this document, can be implemented with well-known digital design methods, including with the use of behavioral language, or with custom-designed digital circuits, all well known in the art.

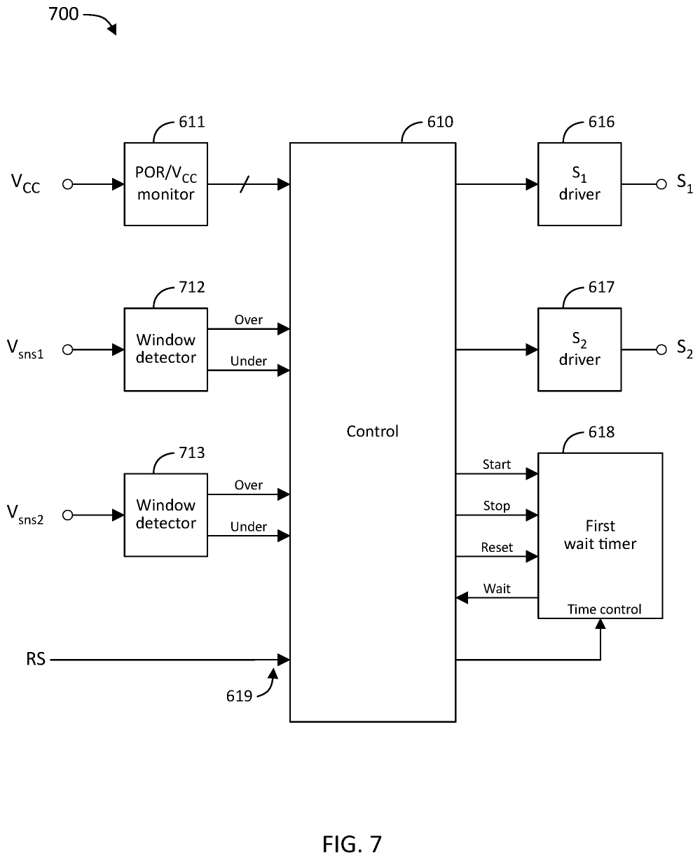

FIG. 7 illustrates an example variation on the control circuit 600 of FIG. 6, with separate inputs for Vₛₙₛ₁ and Vₛₙₛ₂. This can be used in, for example, power management system 400 of FIG. 4. In this variation, the Vₛₙₛ₁ input is coupled with swell window detector 712, and the Vₛₙₛ₂ input is coupled with surge window detector 713. When either Vₛₙₛ₁ or Vₛₙₛ₂ exceeds its window thresholds, the window detectors can provide an overvoltage or undervoltage signal to control logic 610. Some implementations may have just a single comparator for swell detection and/or a single comparator for surge detection, so the swell and/or surge detectors provide a simple “threshold exceeded” signal to control logic 610.

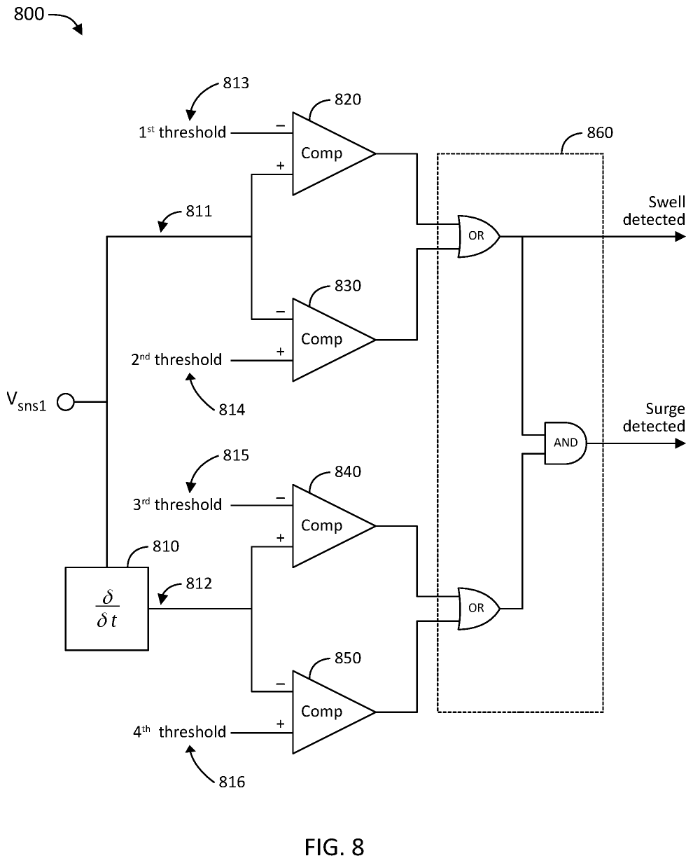

FIG. 8 illustrates an example of a combined swell and surge detector 800. Swell and surge detector 800 includes differentiator 810 (or any other high-pass filter), higher swell comparator 820, lower swell comparator 830, higher surge comparator 840, lower surge comparator 850, and logic circuit 860 which may include combinational logic and/or memory circuits. Higher swell comparator 820, lower swell comparator 830, and differentiator 810 each receive a signal 811 from the power line sense input Vᵢₙ. Higher surge comparator 840 and lower surge comparator 850 each receive a signal 812 from differentiator 810.

Swell detection may include comparing the amplitude of a signal at the power line sense input Vᵢₙ with a first threshold 813 (the upper swell threshold) and/or with a second threshold 814 (the lower swell threshold). Surge detection may include comparing the speed of amplitude change of the signal at the power line sense input Vᵢₙ with a third threshold 815 (the positive surge threshold) and/or with a fourth threshold 816 (the negative surge threshold). Differentiator 810, which is coupled between the power line sense input Vᵢₙ and inputs of higher surge comparator 840 and lower surge comparator 850, may differentiate (or perform another high-pass filtering operation on) the amplitude of the signal at the power line sense input Vᵢₙ to obtain a measure for its speed of change.

Logic circuit 860 receives input signals of the comparators and determines, either by table lookup (from a memory) or by combinational logic, whether the signal at the power line sense input Vᵢₙ qualifies as a swell (its amplitude (at signal 811) is higher than first threshold 813 or lower than second threshold 814). To qualify as a surge, the signal's speed of amplitude change (at signal 812) may need to exceed the positive surge threshold or the negative surge threshold, but also its amplitude (at signal 811) needs to exceed the upper swell threshold or the lower swell threshold). An OR function applied to the output signals of higher swell comparator 820 and lower swell comparator 830 may determine the presence of a swell and provide a “swell detected” signal. An OR function applied to the output signals of higher surge comparator 840 and lower surge comparator 850 may determine whether the speed of amplitude change could indicate a surge, and together with the result of swell detection (an AND function) this determines the presence of a surge (providing a “surge detected” signal). While the example two OR gates and the AND gate in logic circuit 860 are very well suited the explain its functionality, a practical implementation may likely provide the same functionality with NOR gates and/or NAND gates and may implement other functions as well. Thus, any logic circuit that provides the described functionality falls within the scope and ambit of this patent document.

### Considerations

Although the description has been described with respect to particular implementations thereof, these particular implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although the description has been described with respect to particular implementations thereof, these particular implementations are merely illustrative, and not restrictive. For instance, many of the operations can be implemented on a printed circuit board (PCB) using off-the-shelf devices, in a System-on-Chip (SoC), application-specific integrated circuit (ASIC), obviating the need for at least part of any dedicated hardware. Implementations may be as a single chip, or as a multi-chip module (MCM) packaging multiple semiconductor dies in a single package. All such variations and modifications are to be considered within the ambit of the disclosed technology the nature of which is to be determined from the foregoing description.

Any suitable technology for manufacturing electronic devices can be used to implement the circuits of particular implementations, including CMOS, FinFET, GAAFET, BICMOS, bipolar, JFET, MOS, NMOS, PMOS, HBT, MESFET, etc. Different semiconductor materials can be employed, such as silicon, germanium, SiGe, GaAs, InP, GaN, SiC, graphene, etc. Circuits may have single-ended or differential inputs, and single-ended or differential outputs. Terminals to circuits may function as inputs, outputs, both, or be in a high-impedance state, or they may function to receive supply power, a ground reference, a reference voltage, a reference current, or other. Although the physical processing of signals may be presented in a specific order, this order may be changed in different particular implementations. In some particular implementations, multiple elements, devices, or circuits shown as sequential in this specification can be operating in parallel.

It will also be appreciated that one or more of the elements depicted in the drawings/figures can also be implemented in a more separated or integrated manner, or even removed or rendered as inoperable in certain cases, as is useful in accordance with a particular application.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

1. An inrush current protection system, comprising:
a first power terminal (PT1) and a second power terminal (PT2), configured to be coupled with a power source;
a third power terminal (PT3) and a fourth power terminal (PT4), configured to be coupled with a load, and wherein the fourth power terminal is coupled with the second power terminal;
a sequence of devices coupled in series between the first power terminal and the third power terminal, in any order, including:
(a) an inrush-protection device (Rₜ);
a first controlled switch (S₁) with two switch terminals and a first control terminal, wherein the first controlled switch is coupled in parallel with the inrush-protection device; and
a control circuit (CC) coupled with the first power terminal, the second power terminal, and the first control terminal, and wherein the control circuit is configured to:
continually determine if a supply voltage is within an acceptable range and no swell is present;
upon determining that the supply voltage is within the acceptable range and that no swell is present, start a first wait timer and wait until the first wait timer has timed out; and
after the first wait timer has timed out, assert the first control terminal to close the first controlled switch and bypass the inrush-protection device.

2. The inrush current protection system of claim 1, wherein the control circuit is further configured to:
upon determining that the supply voltage is not within the acceptable range or that a swell is present, open the first controlled switch and stop and reset the first wait timer.

3. The inrush current protection system of claim 1, the sequence of devices further including:
(b) a rectifier (R), which comprises at least one of a diode, a half-bridge rectifier, a full-bridge rectifier, a synchronous rectifier, or a partially synchronous rectifier.

4. The inrush current protection system of claim 1, wherein the inrush-protection device includes a resistor.

5. The inrush current protection system of claim 1, wherein the inrush-protection device includes a temperature-dependent resistor (a thermistor).

6. The inrush current protection system of claim 5, wherein the thermistor has a negative temperature coefficient.

7. The inrush current protection system of claim 1, wherein the first controlled switch includes at least one of a relay, a thyristor, an IGBT, a MOSFET, a junction FET, a bipolar transistor, or another controlled switch device with an ON resistance of less than 2 ohms.

8. The inrush current protection system of claim 1, wherein the first controlled switch switches off within 20 milliseconds after the first control terminal has been de-asserted.

9. The inrush current protection system of claim 1, wherein the first controlled switch switches off within 5 microseconds after the first control terminal has been de-asserted.

10. The inrush current protection system of claim 1, wherein the first wait timer times out after at least four milliseconds (4 ms).

11. The inrush current protection system of claim 1, wherein the sequence of devices further comprises:
(c) a second controlled switch (S₂) with two switch terminals and a second control terminal, wherein the second control terminal is coupled with the control circuit; and
wherein the control circuit is further configured to:
before waiting for the first wait timer to time out, close the second controlled switch;
detect if a surge occurs; and
upon detecting that a surge occurs, open the first controlled switch and stop and reset the first wait timer.

12. The inrush current protection system of claim 11, wherein the control circuit is further configured to:
upon determining that the supply voltage is not within the acceptable range or that a swell is present, open the second controlled switch.

13. The inrush current protection system of claim 11, wherein the control circuit is further configured to:
determine if a supply voltage level is falling; and
upon determining that the supply voltage is falling, open the first controlled switch and the second controlled switch.

14. A method of operating a power management system that includes a sequence of devices coupled in series and configured to be coupled between a power source and a load, the sequence of devices comprising an inrush-protection device coupled in parallel with a first controlled switch, the method comprising:
(1a) waiting until a sufficient supply voltage is present;
(1d) when the sufficient supply voltage is present, starting a first wait timer;
(1e) waiting until the first wait timer has timed out; and
(1g) closing the first controlled switch to bypass the inrush-protection device.

15. The method of claim 14, further comprising:
(1b) when the sufficient supply voltage is present, and before starting the first wait timer, determining if no swell is present; and
(2b) upon determining that a swell is present, opening the first controlled switch; stopping and resetting the first wait timer; and returning to (1a).

16. The method of claim 14, further comprising:
(2a) when the sufficient supply voltage is present, continuously determining if the sufficient supply voltage remains present and if no swell is present; and upon determining that the sufficient supply voltage is no longer present or that a swell is present, opening the first controlled switch; stopping and resetting the first wait timer; and returning to (1a).

17. The method of claim 14, wherein the sequence of devices further comprises a second controlled switch, the method further comprising:
(1b) determining if no swell is present;
(1c) upon determining that the sufficient supply voltage is present and no swell is present, and before starting the first wait timer, closing the second controlled switch; and
(1f) determining if a surge is present, and upon determining that a surge is present, returning to (1d).

18. The method of claim 17, further comprising:
(3a) continuously determining if the sufficient supply voltage remains present and if no swell is present; and
(3b) upon determining that the sufficient supply voltage is no longer present or that a swell is present, opening the first controlled switch and the second controlled switch; and returning to (1a).

19. The method of claim 17, further comprising:
(4a) continuously determining if a surge is present; and
(4b) upon determining that a surge is present, opening the first controlled switch and returning to (1d).

20. The method of claim 17, further comprising:
(5a) continuously determining if a level of the supply voltage is falling;
(5b) upon determining that the level of the supply voltage is falling, opening the first controlled switch and the second controlled switch;
(5c) determining if the sufficient supply voltage is present;
(5d) upon determining that the sufficient supply voltage is present, returning to (1a); and
(5e) upon determining that the sufficient supply voltage is not present, ending the method.
